(19) United States
(12) Patent Application Publication
(10) Pub. No.: US 2007/0075069 A1
(43) Pub. Date: Apr. 5, 2007

(54) Method and apparatus for determining type and quantity of food prepared in a cooking appliance

(75) Inventor: Edward J. Musial, Milford, CT (US)

Correspondence Address: EDWARDS & ANGELL, LLP, P.O. BOX 55874, BOSTON, MA, 02205, US

(73) Assignee: Technology Licensing Corporation, Fort Lauderdale, FL (US)

(21) Appl. No.: 11/524,563

(22) Filed: Sep. 21, 2006

Related U.S. Application Data
(60) Provisional application No. 60/718,979, filed on Sep. 21, 2005.

(51) Int. Cl. H05B 1/02

(52) U.S. Cl. 219/497

(57) ABSTRACT

A system for monitoring the type and quantity of food prepared in at least one appliance includes at least one appliance for processing at least one type and quantity of food. A controller associated with the appliance controls the processing performed by the appliance. A backoffice application server is in communication with the controller. The controller prompts a user at the appliance, to input the type of food to be processed and the quantity of food to be processed by the appliance. The controller receives the input and transmits the input to the backoffice application server.

### CROSS-REFERENCE TO RELATED APPLICATIONS

This Application is a Non-Provisional of Provisional Application Ser. No. 60/718,979, entitled METHOD AND APPARATUS FOR DETERMINING TYPE AND QUANTITY OF FOOD PREPARED BY A COOKING APPLIANCE filed on Sep. 21, 2005 under (35 USC 119(e)).

### BACKGROUND OF THE INVENTION

This invention is directed to a method and apparatus for tracking appliance use to determine inventory, and in particular, a method for more accurately tracking the quantity and type of food processed by a particular appliance.

In commercial kitchens, it is known in the art to monitor the operations of a cooking appliance, such as a fryer, an oven or the like. The cooking appliance communicates with a monitoring server which provides backoffice applications for monitoring appliance operation and food consumption. The backoffice application server monitors the use of individual keys at the cooking appliance such as a start cook key, a defrost key or the like. As is known in the art, when a key is depressed, the cooking appliance will signal to the backoffice application server that that particular key was pressed. From this information, knowing what type of process was initiated, the backoffice application determines the type and quantity of the product being prepared and calculates an inventory of cooked food and the amount of food to be reordered.

As is known in the art, the backoffice application server includes memory or functionality to determine which button corresponds to which activity at which appliance. By way of example, button 1 on the fryer indicates that 6 chicken strips are being cooked, while button 2 on the fryer may correspond to the cooking cycle of french fries and a predetermined amount of french fries in weight that is optimally cooked. By monitoring activation of these buttons, the backoffice application server determines, based on expected procedures, the amount of chicken or french fries cooked.

This methodology has been satisfactory in monitoring the general cooking usage of the food quantity and type. However, it suffers from the disadvantage that it assumes that a user consistently cooks the quantity and type required by the functionality corresponding to the pressed key. Therefore, human error, such as five chicken strips instead of six is not accounted for by the backoffice application. Therefore, undercounts and overcounts may occur.

A second problem is that each device is associated with a particular controller. The controller is the device that determines the functionality corresponding to the key, the address of the key and the information reported back to the backoffice application server. The problem that exists is that the addressing is machine-specific so that backoffice application server knows that key three for the fryer controller corresponds to a predetermined weight of French fries, while key one at that particular fryer corresponds to a particular number of chicken strips. However, as is often done in commercial kitchens, if appliances are substituted or rearranged, without calibrating the controller with a backoffice application, the backoffice application is transmitted the wrong data. Therefore, the operations of the backoffice application are out of sync with what is actually happening on the cooking floor. Wrong data is being monitored or the correct data is being monitored in the wrong way. Key three on one fryer may correspond to key nine on another fryer, or even more egregiously, key three on a fryer is not the same as key three on a baking oven.

Accordingly, a method and apparatus for monitoring the type and quantity of food prepared by a particular appliance which overcomes the shortcomings of the prior art is desired.

### BRIEF SUMMARY OF THE INVENTION

The system for monitoring the type and quantity of food prepared in at least one appliance includes at least one appliance for processing at least one type and quantity of food. A controller associated with the appliance controls the processing performed by the appliance. A backoffice application server is in communication with the controller. The controller prompts a user at the appliance to input the type of food to be processed and the quantity of food to be processed by the appliance. The controller receives the input and transmits the input to the backoffice application server.

The controller prompts the user in response to said user indicating to the appliance that a food processing cycle is to begin.

A method determines the type and quantity of food being processed by an appliance during a food processing cycle by depressing a key on the appliance indicating a process to be performed. Providing a controller in communication with the appliance for prompting a user to input the type of product and quantity of product to be processed by the appliance in response to the key being depressed. The controller receives the input and transmits the input to a backoffice application server.

### BRIEF DESCRIPTION OF THE DRAWINGS

For a fuller understanding of the invention, reference is had to the following description taken in connection with the accompanying drawing:

FIG. 1 is a schematic view of a system constructed in accordance with the invention; and

FIG. 2 is a flow chart for determining the type and quantity of food being processed in accordance with the invention.

### DETAILED DESCRIPTION OF THE INVENTION

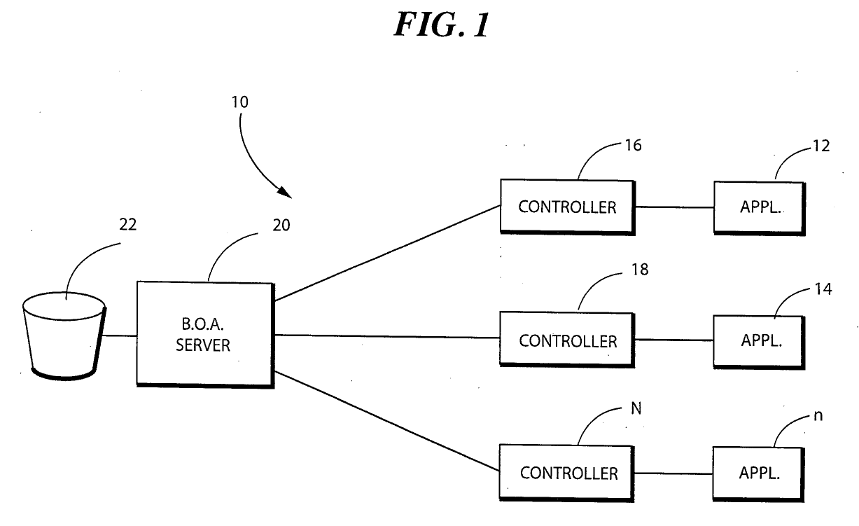

Reference is made to FIG. 1 in which a system, generally indicated as 10, includes a plurality of appliances 12-n provided in a cooking area. Appliance 12 may be a fryer by way of example, appliance 14 may be a rotisserie oven, while appliance N may be a microwave oven. Each of appliances 12-n are capable of being operated in a number of ways dependent upon the type and quantity of food. By way of example, appliance 12, which is a fryer, is capable of frying any number of items which fill a basket as known in the art from one item to a full basket. Additionally, as is known in the art, a single fryer is often used for different types of foods, such as French fries, onion rings, fish filets, shrimp or chicken strips. Each is processed differently and is often controlled by more than one start button.

A controller 16, 18, N is associated with each respective appliance 12-n. As is known in the art, controller 16 controls the operation of the respective appliance 12-n. Controller 16 may be a separate remote item or, in a preferred embodiment, is incorporated into the appliance. A backoffice application server 20 is in communication with each of controllers 16-N.

As is known in the art, backoffice application server 20 is associated with a database 22 and monitors the operation of each appliance 12-n through controller 16-N. Based upon monitoring of operation, backoffice application server 20 determines the amount of each food type being processed to maintain an inventory of food.

In one embodiment, each controller 16-N is assigned an address stored in database 22. Furthermore, each key of appliance 12-n for the addressed controller 16-N is given a predetermined functionality, which is stored in database 22. Therefore, each time controller 16 monitors the depression of a key at an appliance 12, by way of example, such as key one, backoffice application server 20 is able to determine the operation performed as a function of the controller address and key number. However, in accordance with the invention, to verify the accuracy of the information, in one embodiment, when an end user depresses a key at appliance 12, by way of example, controller 16 prompts the user at the appliance by way of LCD, voice generator, LED or other display means as known in the art to input the type of product to be processed and the actual quantity processed. This input information is then transmitted by controller 16 to backoffice server 20. By knowing the address of controller 16, backoffice application server 20 may monitor the use of appliance 12.

By requiring user 12 to verify the food type and count, the processed food is authenticated. Although preferable, there is still some room for human error, although human error is reduced. Therefore, in other embodiments, it is contemplated that a food to be processed may be prepackaged in the quantities required for cooking. Each package may be provided with a barcode or a radio frequency identification (RFID) chip which is scanned by the appliance and directly input to controller 16-N without prompting as a quantity and food type. Processing by backoffice application server is then performed on the information transmitted by controller 16-N.

In another embodiment, a scale is incorporated in appliance 12-n. Therefore, the quantity of food is always known as a function of weight and all that is required is input of the food type which may be done either manually as discussed above or automatically by barcode, RFID or other mechanical indication method. The scale inputs the weight of the food, which is converted to pieces, if necessary, to determine quantity processed.

In a preferred embodiment, not only is the address of each controller 16-N known at backoffice application server 20, but the anticipated functionality or processing of that particular appliance 12 may be stored in database 22. In this way, backoffice application server 20 expects frying functionality from appliance 12. Therefore, if the confirmation to control 16 indicates baking cookies, server 20 determines that this is an inappropriate command and may alert the user that synchronization is required between the controller and backoffice application server 20.

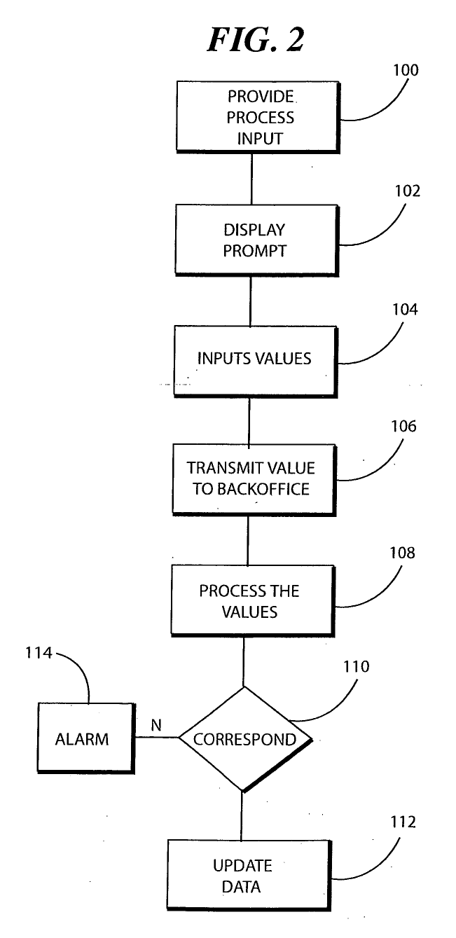

Reference is now made to FIG. 2 wherein the method for determining the type and quantity of food preparation is shown in greater detail. An operator provides an input at the appliance in a step 100 initiating the process to be performed by the appliance. The input being the operation, such as baking, frying, freezing or the like, and the quantity to be processed.

In a step 102, a prompt is provided at the appliance requesting the user to input the type of product and quantity to be processed in response to the input indicated in step 100. Again, this acts as a check to the user to confirm the actual number of items being processed.

In a step 104, the user inputs the values for quantity and type in response to the prompt. As discussed before, the input may be manual by inputting with a keyboard or the like or more automated by use of a scale, a scanner, or any other known method for communicating with an apparatus.

In a step 106, the input values are transmitted, either by control 16 or directly to backoffice application server 20, for processing.

In a step 108, backoffice application server 20 processes the information to determine whether the values correspond to expected values for the appliance information as stored in database 22. If the determination in a step 110 determines that the expected input values do not correspond, then an alarm is transmitted to appliance 12 in a step 112. If the expected values do correspond to expected input value, then inventory calculations are performed by backoffice application server 20 to update the cooking data as well as inventory data in a step 112.

By confirming the food type and quantity at appliance 12, the accuracy of the inventorying process at backoffice application server 20 is greatly enhanced. Human error is significantly reduced if not eliminated. Furthermore, by identifying and storing the anticipated functionality of an appliance at a particular address controller, the backoffice application server 20 can determine that an appliance has been changed.

In the above embodiment, communication between the appliances, controllers and backoffice application servers may be wireless, across the Internet, by cellular communication, or by hard wiring.

Thus, while there have been shown, described and pointed out novel features of the present invention as applied to preferred embodiments thereof, it will be understood that various omissions and substitutions and changes in the form and detail are contemplated so that the disclosed invention may be made by those skilled in the art without departing from the spirit and scope of the invention. It is the intention, therefore, to be limited only as indicated by the scope of the claims appended hereto. It is also to be understood that the following claims are intended to cover all of the generic and specific features of the invention herein described and all statements of the scope of the invention, which, as a matter of language, might be said to fall therebetween.

What is claimed as new and desired to be protected by Letters Patent of the United States is:

1. A system for monitoring the type and quantity of food prepared in at least one appliance comprising:
at least one appliance for processing at least one type and quantity of food;
a controller associated with said appliance for controlling the processing performed by the appliance; and
a backoffice application server in communication with said controller, said controller prompting a user at said appliance to input the type of food to be processed and the quantity of food to be processed by said appliance, said controller receiving said input and transmitting said input to said backoffice application server.

2. The system of claim 1, wherein said controller prompts said user in response to said user indicating to said appliance that a food processing cycle is to begin.

3. The system of claim 1, wherein said back office application server retrieves predetermined functionality from said database in accordance with said user input; and said controller receives said predetermined functionality from said database in accordance with said user input.

4. The system of claim 1, further comprising:
a scale associated with said controller;
said controller receiving from said scale a weight value related to the food to be processed by said appliance, said controller receiving said user input and said weight, and transmitting said user input and said weight to said back office application server.

5. A system for monitoring the type and quantity of food prepared in at least one appliance comprising:
at least one appliance for processing at least one type and quantity of food;
a controller associated with said appliance for controlling the processing performed by the appliance;
a food package encoded with information for food contained in said food package;
a scanning device associated with said controller for obtaining said information from said food package;
a back office application server in communication with said controller, said controller receiving said information and transmitting said information to said back office application server.

6. The system of claim 5 where said scanning device is a barcode reader.

7. The system of claim 5 where said scanning device is an RFID receiver.

8. The system of claim 5 where said information is encoded using a barcode.

9. The system of claim 5 where said information is encoded using RFID.

10. A system for monitoring the type and quantity of food prepared in at least one appliance comprising:
at least one appliance for processing at least one type and quantity of food;
a controller associated with said appliance for controlling the processing performed by the appliance, and said controller prompting a user at said appliance, to input the type of food to be processed;
a back office application server in communication with said controller;
said controller receiving said input and transmitting said input to said back office application server;
a database associated with said back office application server, and said database containing information indicating the expected input from said controller;
said back office application server determining if said input for said controller and said information contained in said database match.

11. The system of claim 10 where said back office application server generates an alert if said input and said information do not match.

12. The system of claim 11 where said alert indicates to said user that synchronization is necessary.

13. The system of claim 10 where said back office application server determines if an appliance has been changed.

14. A method for determining the type and quantity of food being processed by an appliance-during a food processing cycle comprising:
providing a process input to said appliance indicating a process to be performed;
providing a controller in communication with said appliance for prompting said user to input the type of product and quantity of product to be processed by said appliance in response to said process input; and
said controller receiving said input and transmitting said input to a backoffice application server.

15. The method for determining the type and quantity of food of claim 14, further comprising the steps of determining whether the input corresponds to an expected input value and producing an alarm if the value does not correspond to an expected value.

16. The method for determining the type and quantity of food of claim 14, further comprising the step of determining whether the input corresponds to an expected value of the input, and updating inventory data if the input value substantially corresponds to an expected value.
